(19) United States
(12) Patent Application Publication
(10) Pub. No.: US 2006/0203205 A1
(43) Pub. Date: Sep. 14, 2006

(54) Illumination source device and projection image display device

(76) Inventor: Masayuki Inamoto, Saitama (JP)

Correspondence Address: YOUNG & THOMPSON, 745 SOUTH 23RD STREET, 2ND FLOOR, ARLINGTON, VA, 22202, US

(21) Appl. No.: 11/371,072

(22) Filed: Mar. 9, 2006

(30) Foreign Application Priority Data
Mar. 9, 2005 (JP) 2005-065370

(51) Int. Cl. G03B 21/16

(52) U.S. Cl. 353/52

(57) ABSTRACT

A simple and compact illumination source device capable of efficiently cooling an LED comprises a mounting base board having a heat conductivity higher than 50 W/m·K for mounting an LED element thereon through heat transfer member, a metal supporting structure for supporting the mounting base board and a collimation lens held by the metal support structure. Heat generated by the LED element is transferred partly to the metal support structure and partly to the base mounting board and then released into the air through the metal support structure and partly to the base mounting board. The illumination source device is suitably used for projection image display devices.

### BACKGROUND OF THE INVENTION

1. Field of the Invention

The present invention relates to an illumination source device and a projection image display device with the illumination source device.

2. Description of Related Art

There have been known various kinds of projection image display apparatuses for displaying an image onto a screen such as a projector in which LCD panels, of a transparent or a reflective type, or DMD (Digial Micro-mirror Device) panels are used to modulate light for projecting an LED display image or an image provided by a DMD. Such a projection image display apparatus is equipped with an illumination source device. It is known to be preferred to use an illumination source device that provides a high intensity light beam for illumination and a uniform luminance distribution to an LCD panel. Conventionally, it has been popular to employ high intensity discharge lamps including an ultra-high pressure mercury lamp, a metal halide lamp, a xenon lamp and the like as a light source. However, the illumination source device using a high intensity discharge lamp is oversized, while being capable of providing a high intensity illumination light beam.

In light of the drawbacks of the conventional projection image display apparatuses, it has been proposed to use a light emitting diode (LED), that is small in size and light in weight, for the illumination source device. However, it has come to light that the LED produces a considerable amount of heat when using it with a practical luminance. The LED encounters deterioration in property and diminution in useful life span when the LED producing heat in excess.

In order to solve this problem existing with the LED, there has been proposed an illumination source device in which a mounting base board having a draft bore or draft bores is used to mount a plurality of LED elements thereon so as to enhance the heat releasing efficiency of the illumination source device. For a more complete description of this problem and a proposed solution, see Unexamined Japanese Patent Publication No. 2004-95655, issued Mar. 25, 2004.

### SUMMARY OF THE INVENTION

It is therefore an object of the present invention to provide an illumination source device using an LED element as a light source which is simple and compact in structure and capable of cooling the LED element.

It is another object of the present invention to provide a projection image display device accompanied by the illumination source device using an LED element.

According to one aspect of the present invention, the illumination source device comprises an LED element for emitting a light beam for illumination, a mounting base board having a heat conductivity higher than 50 W/m·K for mounting the LED element thereon, and a metal supporting structure for supporting the mounting base board. The metal supporting structure has an axial bore formed therein through which the light beam for illumination passes and which has an axial line perpendicular to the mounting base board or is made in the form of a hollow body. The hollow metal supporting structure may be provided with fins extending exterior side walls thereof for releasing heat building up within the axial bore.

It is preferred for the illumination source device to comprise a collimator lens mounted in the axial bore for collimating a light beam emitted from the LED element. It is further preferred for the illumination source device from a practical standpoint to be accompanied by an air blower that is disposed closely behind the illumination source device so as to produce and direct airflows against the mounting base board and around the metal supporting structure.

The illumination source device comprising the mounting base board having a heat conductivity higher than 50 W/m·K on which an LED element is mounted thereon and the metal supporting structure which supports the mounting base board transfers heat produced by the LED element to both the mounting base board and the metal supporting structure and then releases it into the air. As a result, the LED is effectively cooled, thereby being prevented from being overheated to a higher temperature, and hence, from encountering not only deterioration in optical property but also diminution in useful life span. Furthermore, because the metal supporting structure has an axial bore through which the light beam for illumination passes and is provided with a collimator lens mounted in the axial bore for collimating the light beam emitted from the LED element, the illumination source device provides an effectively collimated light beam for illumination.

According to another aspect of the present invention, the projection image display device for displaying images on a screen is accompanied by the illumination source device for projecting an LED display image on the screen. This projection image display device is compact in structure by virtue of the compactness of the illumination source device.

### BRIEF DESCRIPTION OF THE DRAWINGS

The foregoing and other objects and features of the present invention will be clearly understood from the following detailed description when reading with reference to the accompanying drawings, wherein the same reference signs have been used to denote same or similar parts throughout the drawings, and in which:

FIG. 1 is a schematic view of an LCD projector according to an embodiment of the present invention;

FIG. 2 is a longitudinal sectional view of an illumination source device according to an embodiment of the present invention;

FIG. 3 is a longitudinal sectional view of a illumination chart illustrating an LED light source unit; and

FIG. 4 is a perspective view illustrating an appearance of an illumination source device with an air blower.

### DETAILED DESCRIPTION OF THE PREFERRED EMBODIMENTS

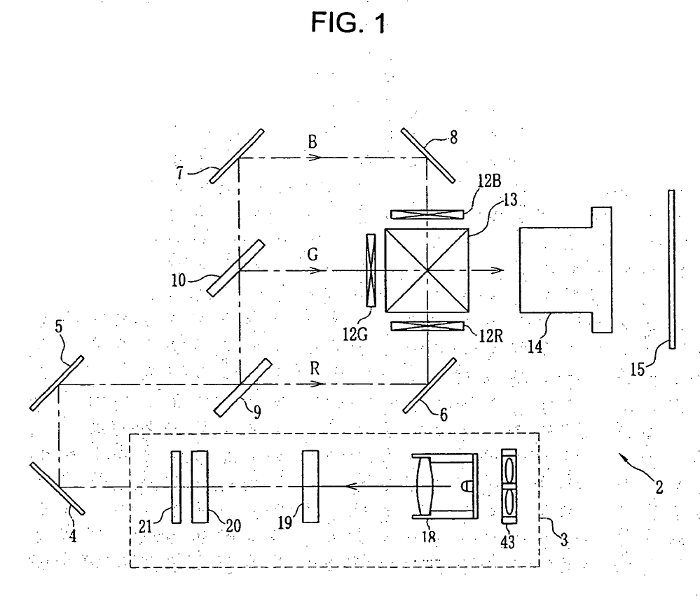

Referring to the accompanying drawings in detail, and, in particular, to FIG. 1 showing an LCD (Liquid Crystal Display) projection system 2 which is used in combination with an illumination source device 3 according to an embodiment of the present invention, the LCD projection system 2 comprises a mirror arrangement comprising a plurality of, four in this embodiment, reflecting mirrors 4 to 8, dichroic mirrors 9 and 10, transmissive LCD (Liquid Crystal Display) panels 12R, 12G and 12B, a dichroic prism assembly 13 schematically illustrated and a projection lens 14 schematically illustrated. Specifically, the reflecting minors 4 and 5 are disposed with their reflecting surfaces orthogonally oriented to reflect light incident thereon at a right angle, respectively. The dichroic minors 9 and 10 disposed in parallel with the mirror 5 transit specific components of white light, respectively, and reflect the remaining components of the white light at a right angle. More specifically, the dichroic mirror 9 transmits only red (R) light and reflects the remaining components, namely a green (G) and blue (B) light of the light incident thereupon. The dichroic mirror 10 transmits the blue (B) light reflected by the dichroic mirror 9 and reflects the remaining component, namely the green (G) light, of the light reflected by the dichroic mirror 9. The mirror 6 that is disposed in parallel with the dichroic mirror 9 and opposed to the LCD panel 12R at 45 degrees reflects the red (R) light at a right angle to direct it toward the LCD panel 12R. The dichroic mirror 10 that is opposed to the LCD 12G at 45 degrees reflects the green (G) light at a right angle to direct it toward the LCD panel 12G. The reflecting mirror 7 that is disposed in parallel with the dichroic miirror 10 and orthogonally oriented to the reflecting mirror 8 reflects the red (R) light at a right angle to direct it toward the reflecting mirror 8. The reflecting mirror 8 that is opposed to the LCD panel 12B at 45 degrees reflects the blue (B) light at a right angle to direct it toward the LCD panel 12B. The LCD panels 12R, 12G and 12B are disposed adjacent to surfaces 13a, 13b and 13c of the dichroic prism assembly 13, respectively. The LCD panels 12R, 12G and 12B, that are elements made up of a liquid crystal and a polarizing film sandwiched between two transparent glass plates, change their transmittance for individual picture elements by changing the directions of polarization of linearly polarized light, respectively, for displaying three single color images, i.e. red, green and blue images. The dichroic prism assembly 13 integrates the red, green and blue light coming out of the LCD panels 12R, 12G and 12B, respectively, together, thereby forming a color image to be projected onto a screen 15 by the projection lens 14.

The illumination source device 3 includes a light source unit 18, an integrator made up of lenses 19 and 20, and a polarization direction controlling element 21. The light source unit 18, which will be described in detail later, emits a white light beam for illumination containing red (R), green (G) and blue (B) components of light forward. The integrator lenses 19 and 20 are disposed in front of the light source unit 18 to uniformize the white light beam from the light source unit 18. The polarization direction controlling element 21 is disposed on one side of the integrator lenses 19 and 20 opposite to the light source unit 18 to change polarization directions of the white light beams passing through the integrator lenses 19 and 20. There is provided an air blower 43 closely behind the light source unit 18 for cooling the light source unit 18.

The while light beam coming out of the illumination source device 3 enters the liquid crystal projector 2. Specifically, the collimated and polarized white light beam for illumination is reflected at a right angle by the reflecting minor 4 and further reflected at a right angle by the reflecting mirror 5, and then directed to the dichroic mirror 9. The white light beam incident upon the dichroic mirror 9 partly transmits through and is partly reflected at a right angle by the dichroic mirror 9. That is, a red component of the light beam transmits through the dichroic mirror 9 and directed toward the reflecting mirror 6. The red light beam incident upon the reflecting mirror 6 is reflected at a right angle by the reflecting mirror 6 to illuminate the LCD panel 12R. At the same time, the remaining components, namely green and blue, of the light beam are reflected at a right angle by the dichroic mirror 9 and directed toward the dichroic mirror 10. The light beam incident upon the dichroic mirror 10 partly transmits through and is partly reflected at a right angle by the dichroic mirror 10. That is, the blue light beam transmits through the dichroic mirror 10 and is directed toward the reflecting mirror 7. At the same time, the remaining constituent, namely the green light, of the light beam is reflected at a right angle by the dichroic mirror 10 to illuminate the LCD panel 12G. The blue light beam incident upon the reflecting mirror 7 is reflected at a light angle by the reflecting mirror 7 and subsequently reflected at a right angle by the reflecting mirror 8 to illuminate the LCD panel 12B. The red, green and blue components of light entering and exiting from the LCD panels 12R, 12G and 12B, respectively are integrated together by the dichroic prism assembly 13 to provide a color image for projection on the screen 15 by the projection lens system 14.

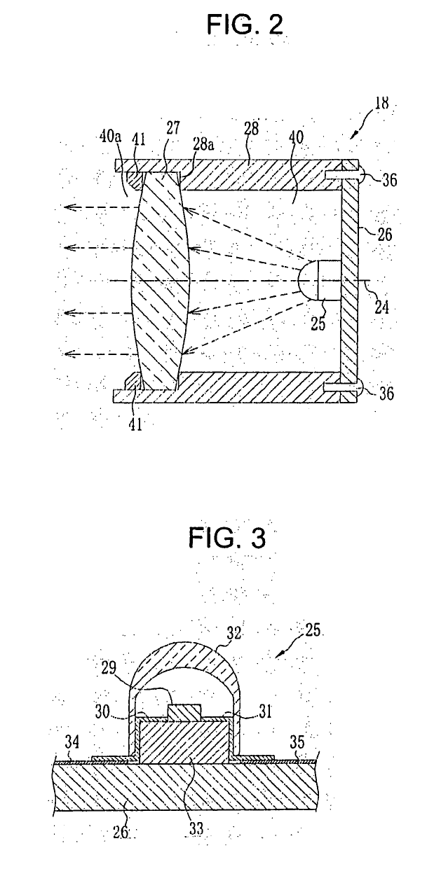

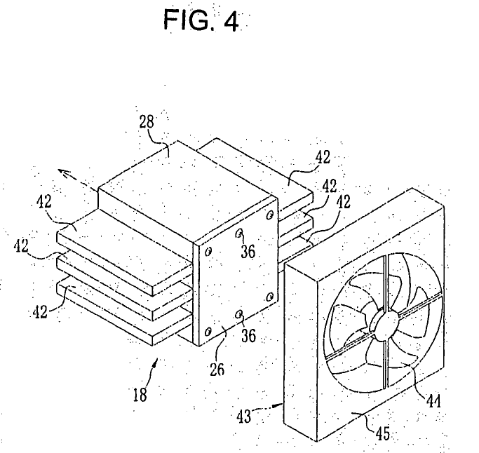

Referring to FIG. 2 showing the light source unit 18 in longitudinal section, the light source unit 18 comprises a unit of light emitting diode (which is hereinafter referred to as an LED unit) 25 mounted on a rectangular mounting base board 26 (see FIG. 4) and a collimator lens 27 mounted in a rectangular hollow housing 28. The housing 28 generally has a rectangular bore 40 and a cylindrical bore 40a formed at a front end thereof for snuggly holding the collimator lens 27 therein. These rectangular bore 40 and cylindrical end bore 40a are different in bore diameter so as to form a shoulder 28a between them. The collimator lens 27 is abutted by the shoulder 28a at a rear peripheral edge thereof and bore down against the shoulder 28a by a rubber fixing ring 41 from the front. In this way, the collimator lens 27 is precisely mounted in the supporting structure in a given position. The mounting base board 26 is closely secured to the housing 28 by set screws 36 so as to place the LED unit 25 in alignment with a center axis 24 of the housing 28 which is substantially coincide with or in parallel with an optical axis of the collimator lens 27. It is preferred for the mounting base board 26 to be made of a resin board or a ceramic board which should have a comparatively high heat conductivity, desirably a heat conductivity higher than 50 W/m·K. On the other hand, the housing 28 is made of metal.

Referring to FIG. 3 showing the LED unit 25 mounted on the mounting base board 26 in detail, the LED unit 25 comprises a light emitting diode (LED) chip 29 which emits white light, a heat transfer member 33 to which LED chip 29 is tightly mounted, positive and negative leading electrodes 30 and 31 connected to LED chip 29, and a bell-shaped outer envelop or protective cap 32 covering LED chip 29. The positive and negative leading electrodes 30 and 31 are connected to patterned circuits 34 and 35, respectively, formed on the mounting base board 26 when the LED unit 25 is fitted onto the mounting base board 26. The protective cap 32 which is made of a transparent resin material, is shaped so as to have a wall thickness gradually increasing from the periphery toward the tiptop so as to collect light emanating from LED chip 29 and direct the light toward the collimator lens 27 like a kind of convex lens. It is preferred for the heat transfer member 33 to be made of a metal block, a resin block or a ceramic block which should have a comparatively high heat conductivity. In the case of employing a metal block, the heat transfer member 33 is electrically isolated from LED chip 29 and the electrodes 30 and 31 by insulating coatings in order that the heat transfer member 33 is prevented from being electrified. The heat transfer member 33 is tightly mounted onto the mounting base board 26 when the LED unit 25 is fitted onto the mounting base board 26. According to the LED unit 25 thus structured, heat that LED chip 29 radiates is transferred from the heat transfer member 33 to the mounting base board 26.

As shown in FIG. 4, the housing 28 is provided with a plurality of fins 42 extending from exterior side walls thereof through which heat building up within the bores 40 and 40a is released. The air blower 43 disposed closely behind the light source unit 18 comprises a blower fan 44 and a fan casing 45 in which the blower fan 44 is supported for rotation. Although not shown in FIG. 4, the fan casing 45 is provided with a drive mechanism for rotating the blower fan 44. The air blower 43 causes flows of air from the front side (on the side of the light source unit 18) to the back side thereof. Consequentially, airflows occur around the mounting base board 26 and the housing 28 to thrust away heated by radiation from the mounting base board 26 and the housing 28 backward, so as thereby to cool the mounting base board 26 and the housing 28. In this instance, the air blower 43 may be of a type causing airflows blowing against the mounting base board 26 and the housing 28.

In the operation, when the liquid crystal projector 2 is powered on to activate the light source unit 18, the LED chip 29 is excited to emit white light. The white light is collected by the protective cap 32 and enters and exiting as a collimated white light beam from the collimator lens 27. The collimated white light beam enters and exits from the integrator lenses 19 and 20 and then enters the polarization direction controlling element 21. The white light beam coming out of the illumination source device 3 that is uniformized in polarization direction is directed as illumination light toward the LCD projection system 2. The white light beam incoming the LCD projection system 2 is split into three light beams of red, green and blue components by the dichroic mirrors 9 and 10. The light beams of red, green and blue components are modulated by the LCD panels 12R, 12G and 12B, respectively, in accordance with image data provided by a video signal. The light beams of red, green and blue components are then recombined by the dichroic prism assembly 13 and projected as a color image onto the screen 15 by the projection lens 14.

When having a long run of the LCD projector 2, the LED chip 29 is accompanied by heat. However, according to the light source unit 3, the heat radiated from the LED chip 29 is transferred to the mounting base board 26 through the heat transfer member 33 and then partly released into the air from the mounting base board 26. Concurrently, the heat transferred to the mounting base board 26 is partly transferred to and released into the air from the housing 28. In this way, the LED chip 29 is well cooled. In particular, the air blower 43 provided closely behind the light source unit 18 facilitates release of a large amount of heat for efficient cooling of the LED chip 29. Consequentially, the LED chip 29 is prevented from deteriorating in property and encountering diminution in useful life span. Furthermore, because the light source unit 18 is simple and compact in structure, it is ensured to provide a compact design for the illumination source device 3, and hence the LCD projector 2.

Although, in the above embodiment, the LED unit 25 has an integral structure in which the LED chip 29, the leading electrodes 30 and 31, the heat transfer member 33 and the bell-shaped protective cap 32 are preassembled as one whole unit, a similar structure can be taken in a case where the LED chip 29 is mounted directly mounted on the mounting base board 26 with the same effect as described above.

In alternative embodiments, a plurality of white light LEDs or different colors of LEDs may be employed in place of the single white light LED unit 25, and, in this instnce, these LEDs can be densely-mounted on the mounting base board 26 of the light source unit 18. The housing 28 may be in any desired shape in place of rectangular as long as it is suitable for suitable for supporting the mounting base board 26 thereon.

The LCD panels 12R, 12G and 12B operative to modulate the light beams of red, green and blue components, respectively, may be of a reflective type LCD panels or replaced with DMDs. Further, the light source unit 18 may be used in combination with projectors of a type other than a projection type and equipments that need illumination.

It is to be understood that although the present invention has been described with regard to preferred embodiments thereof various other embodiments and variants may occur to those skilled in the art, which are within the scope and spirit of the invention, and such other embodiments and variants are intended to be covered by the following claims.

What is claimed is:

1. An illumination source device having a light source for generating light for illumination, comprising:
an LED element for emitting light for said illumination;
a mounting base board having a heat conductivity higher than 50 W/m·K for mounting said LED element thereon; and
a metal supporting structure for supporting said mounting base board.

2. An illumination source device as defined in claim 1, wherein said metal supporting structure has an axial bore formed therein through which said light from said LED element passes and to which said mounting base board is attached in perpendicular to an axial line of said axial bore.

3. An illumination source device as defined in claim 1, further comprising an air blower that is separately disposed behind said mounting base board and produces airflows against said mounting base board and around said metal supporting structure.

4. An illumination source device as defined in claim 1, further comprising fins extending exterior side wall thereof for releasing heat building up within said metal supporting structure.

5. A projection image display apparatus for projecting an image onto a screen, said projection image display apparatuses comprises an apparatus for displaying an (LED) image on a screen and an illumination source device for projecting said (LED) display image,
wherein said illumination source device comprises:
an LED element for emitting light for said illumination;
a mounting base board having a heat conductivity higher than 50 W/m·K for mounting said LED element thereon; and
a metal supporting structure for supporting said mounting base board.

6. A projection image display apparatus as defined in claim 5, wherein said metal supporting structure has an axial bore formed therein through which said light from said LED element passes and to which said mounting base board is attached in perpendicular to an axial line of said axial bore.

7. A projection image display apparatus as defined in claim 5, further comprising an air blower that is separately disposed behind said mounting base board and produces airflows against said mounting base board and around said metal supporting structure.

8. A projection image display apparatus as defined in claim 5, further comprising fins extending exterior side wall thereof for releasing heat building up within said metal supporting structure.
